(19) United States
(12) Patent Application Publication
(10) Pub. No.: US 2005/0156424 A1
(43) Pub. Date: Jul. 21, 2005

(54) Steering column and manufacturing method thereof

(75) Inventor: Olaf Muller, Russelsheim (DE)

Correspondence Address: FLEIT KAIN GIBBONS GUTMAN BONGINI & BIANCO, COURVOISIER CENTRE II, SUITE 404, 601 BRICKELL KEY DRIVE, MIAMI, FL, 33131, US

(73) Assignee: THYSSENKRUPP PRESTA AG, ESCHEN (LI)

(21) Appl. No.: 11/022,280

(22) Filed: Dec. 21, 2004

Related U.S. Application Data
(63) Continuation-in-part of application No. 10/725,963, filed on Dec. 1, 2003, now abandoned.
Application No. 10/725,963 is a continuation-in-part of application No. 10/030,774, filed on Jun. 3, 2002, now abandoned.

(30) Foreign Application Priority Data
Feb. 29, 2000 (DE) 200 03 707.2

(51) Int. Cl. B62D 1/18

(52) U.S. Cl. 280/777

(57) ABSTRACT

A steering column in which a guide, an outer housing, a steering shaft housing and/or a guiding plate include one or more extruded profiles and in which are accommodated a steering shaft housing and load absorbencies.

### CROSS-REFERENCE TO RELATED APPLICATIONS

This is a continuation-in-part of U.S. patent application, Ser. No. 10/725,963 filed Dec. 1, 2003, which is a continuation-in-part of U.S. patent application, Ser. No. 10/030,774 filed Jun. 3, 2002. The contents of which are incorporated by reference in their entirety.

### BACKGROUND OF THE INVENTION

1. Field of the Invention

The invention generally refers to a steering column and a manufacturing method thereof.

2. Prior Art

Current casings for steering columns for motor vehicles are metal sheet constructions or assemblies of mainly aluminium or magnesium cast parts. New requirements as for multiple load restrictions for different accident types, integrated air bags, movement cylinders for certain crash types and other things make these components increasingly expensive.

### BRIEF SUMMARY OF THE INVENTION

Therefore, the invention has the object to provide a steering column as well as a manufacturing method thereof wherein expensive treatment, costs and weight are saved.

Therefore, according to the present invention it is provided to use at least one extruded or extrusion profile or shape for a housing of the steering columns. Thereby, the variety of requirements corresponding to which the components are mounted in and/or at the housing of the steering column in an easy way, are optimally taken into consideration.

The object of the invention is especially achieved by a novel steering column, as well as a manufacturing method thereof, according to the following disclosure.

Thus, a steering column is provided in which an outer housing, a steering shaft housing and/or a guiding plate include an extruded or extrusion profile or shape.

Preferably, the structure for longitudinal and/or vertical adjustment of the steering column are accommodated. Especially the structure for longitudinal and/or vertical adjustment of the steering column are accommodated in the extruded profiles of the guiding plate and of the outer housing.

Alternatively or additionally, it can be provided that structure for the accident-caused movement of the steering column away from the driver are accommodated in the extruded profile or in the extruded profiles. A preferred further development thereof is that the structure for the accident-caused movement of the steering column away from the driver includes load absorbing members which are accommodated in the extruded profile or in the extruded profiles wherein the load absorbing members include especially two load absorbencies which can be activated or deactivated in dependence on preconditions determined by sensors that detect, i.e. the belt fastened condition, position of the driver and/or the size of the driver. Furthermore, it is of advantages in the present embodiment if the means for the accident-caused movement of the steering column away from the driver is accommodated in an extended housing integral with the extruded profile of the guiding plates in cooperation with the outer housing. Furthermore, the means for the accident-caused movement of the steering column away from the driver can include one or more pyrotechnic driving members, which are accommodated in the extruded profile or the extruded profiles. It can further be provided with preference that the structure for the accident-caused movement of the steering column away from the driver include pyrotechnic unlocking structure for the longitudinal adjustment of the steering column and/or unlocking or locking structure for the load absorbing member(s).

In the steering column, according to the invention, it can be further provided that structure for the protection of the driver's knees or legs are integrated in the extruded profile or in the extruded profiles. This structure for the protection of the driver's knees or legs preferably includes a knee/leg air bag and/or a knee impact plate especially movable towards the driver in an accident, and preferably load absorbingly mounted.

The object of the invention is also achieved by a manufacturing method for a steering column wherein an outer housing, a steering shaft housing and/or a guiding plate are at least partly made of extruded or extrusion profile or shape.

Further preferred and advantageous embodiments of the invention result from the following disclosure of preferred embodiments of the invention.

### BRIEF DESCRIPTION OF THE SEVERAL VIEWS OF THE DRAWINGS

In the following, the invention is explained in more detail based on the exemplary embodiment examples with reference to the drawings. In the drawings:

FIGS. 1 to 11 show different sections of a basic first embodiment example of the steering column or apparatus with some, given the case, alternative design variants, specifically:

FIG. 1 shows an especially simple form of a longitudinally and vertically adjustable steering.

FIG. 2 shows the support of the steering shaft housing in a swivel bearing.

FIG. 3 shows a development of this steering column meeting the requirement to have a steering-integrated air bag, two crash-depending load absorbencies and an active pyrotechnically activated steering column.

FIG. 4 shows an enlarged view of longitudinal section F of FIG. 3.

FIG. 5 shows section A of FIG. 3.

FIG. 6 shows section B of FIG. 3.

FIG. 7 shows section C of FIG. 3.

FIG. 8 shows section D of FIG. 3.

FIG. 9 shows a further alternative of the steering shaft housing.

FIG. 10 shows the steering shaft in the steering shaft housing, the lock screw and the swivel bearing in the horizontal section E.

FIG. 11 shows the lock of the comfort adjustment on both sides as an alternative to the basic embodiments in FIG. 1 and 2.

FIGS. 12 to 17 show different sections of a second embodiment example of the steering column or apparatus with some, given the case, alternative design variants.

The same reference symbols in the individual figures and illustrations of the drawings refer to same or similar or equally the same or similar working components. Based on the illustrations in the drawings such features become evident, which do not have independent reference symbols, on the fact whether such features are subsequently described or not. On the other hand, features that are included in the present description, but not visible or illustrated in the drawings are easily evident to a ordinary person skilled in the art.

### DETAILED DESCRIPTION OF THE INVENTION

In all figures of the drawings, a steering column is, as far as it is illustrated or visible therein, generally marked, with the reference numeral 100.

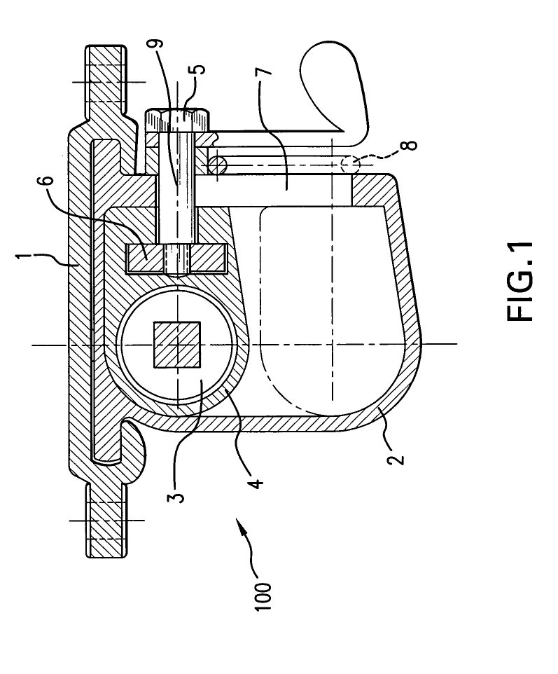

FIG. 1 shows an especially simple form of a longitudinally and vertically adjustable steering column that can be provided, for example, with a load absorbing sheet (not shown) in a position integrated in a guiding plate 1. In this guiding plate 1, an outer housing 2 is guided, which moves in a crash relative to the guiding plate 1 upon, e.g., destruction/load reduction by a deformable load absorbing sheet (not shown) coupling these two components. Outer housing 2 may also be called a steering column housing or contain a steering column housing.

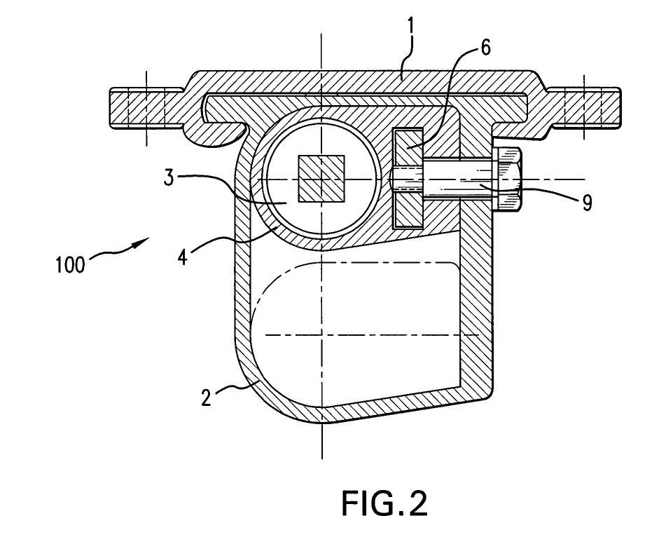

In this outer housing 2, a steering shaft 3 lies in a steering shaft housing 4. This steering shaft housing 4 can be longitudinally and vertically adjusted after releasing a lock screw 5 by means of a positioning lever 6 with a lock element in an adjustment slot 7. Hereby, an equalizing spring 8 in the form of a “coil spring” acts against the weight of the steering shaft 3. FIG. 2 shows the support of the steering shaft housing 4 in a swivel bearing 9.

All parts of this vertically and longitudinally adjustable steering column, namely guiding plate 1, outer housing 2 and steering shaft housing 4, are cheaply produced as extruded or extrusion profiles or shapes. The outer housing 2 is shiftable in the guiding plate 1, guided in sliding relationship, since the crash case, outer housing 2, completely surrounds the vertically and longitudinally adjustable shaft housing 4. This has the advantage that there are no projecting components injuring the knees in a crash. The lock screw 5 is also cost-savingly guided in a longitudinal slot (not shown) of the extruded profile of the steering shaft housing 4. The swivel bearing 9 is also positioned in the adjustment slot and, of course, swivably mounted in the outer housing 2. On the whole, a cost-effective, compact longitudinally and vertically adjustable steering column assembly without projecting parts being harmful in a crash.

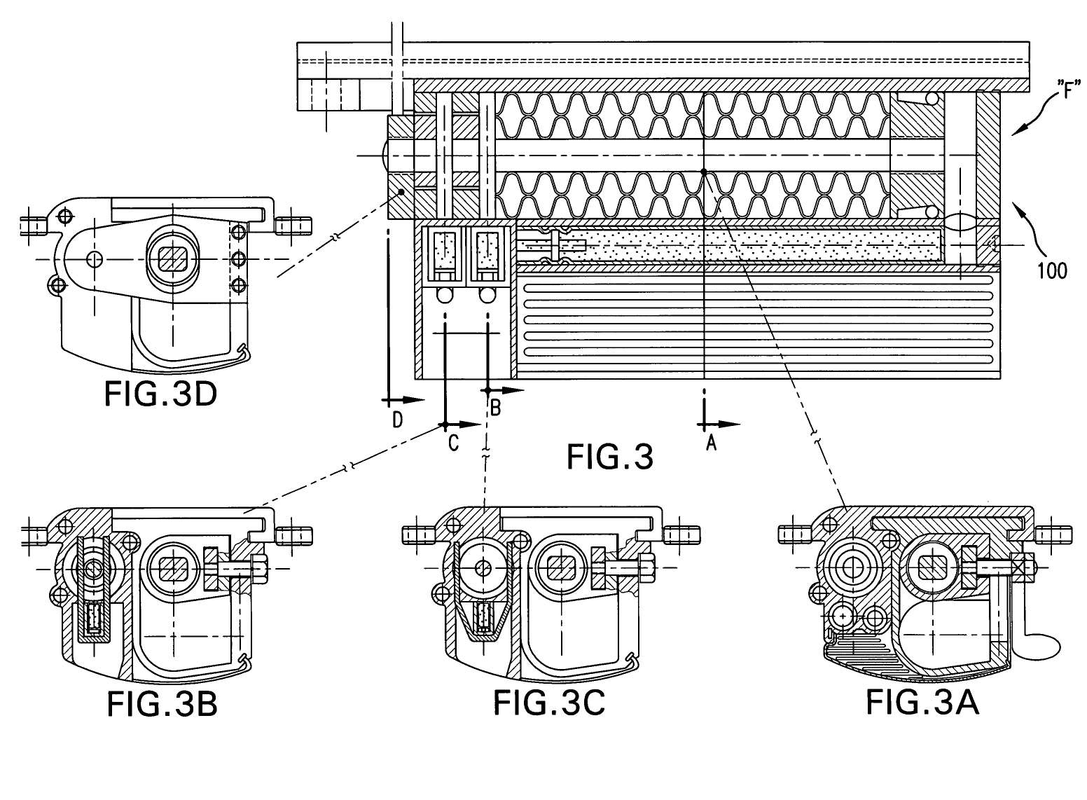

FIG. 3 shows a development of this steering column meeting the requirements of a steering-integrated air bag, two crash-depending load absorbencies and an active pyrotechnically activated steering column. FIG. 3 shows the association of the sections of the following figures as an overview. Herein the object according to the invention is also to accommodate further elements of the passive safety in the extruded or extrusion profile or shape of an “extended” housing 1′ formed preferably integral with, but may be rigidly attached, to guide plate 1, see FIGS. 1 and 2, in a most simple and cost-effective way.

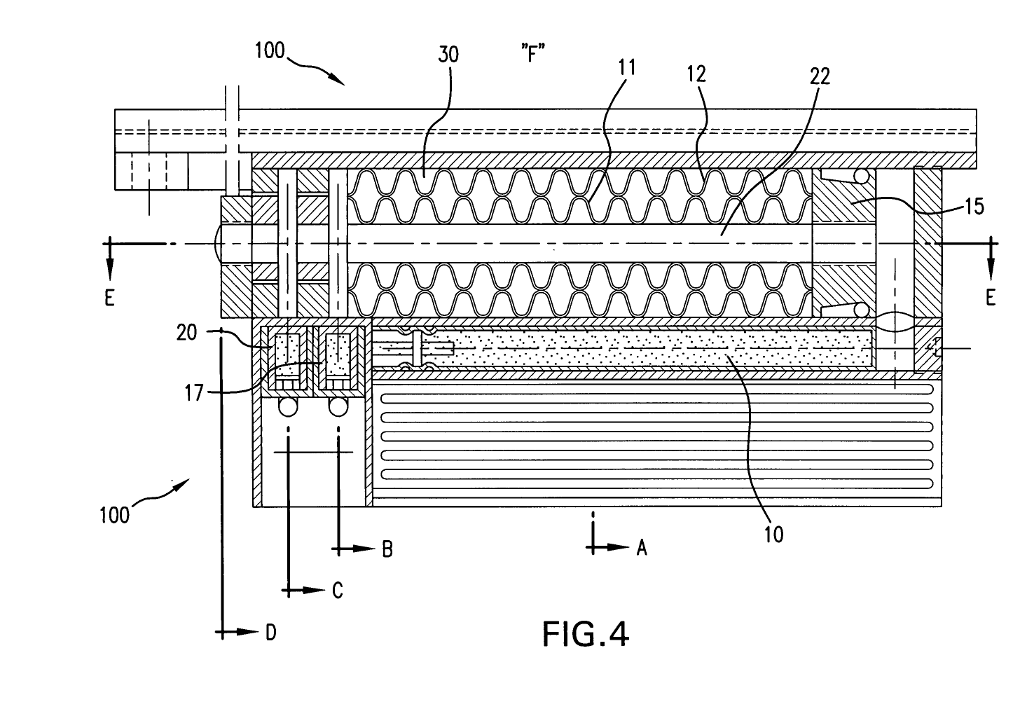

FIG. 4 shows in an enlarged view the longitudinal section F of FIG. 3 with load absorbencies 11 and 12 forming the load absorbing structure (cylinders and pistons with collapsible corrugated cylinders), and a pyrotechnic driving generator 10. Two interweaving load absorbencies 11 and 12 are accommodated in a cylinder-shaped cavity 30 together with a piston 15 and a piston rod 22 connected for crash alternatives described later on. Furthermore, the longitudinal section of FIG. 4 shows the generator 10 needed if required to “lower” the steering column (not shown). All these elements are simply accommodated in the extruded or extrusion profile or shape of the extended housing 1′ of the guide plate 1. At the lower side of the extruded profile extended housing 1′ there are pyrotechnic cartridges 17 and 20 to unlock, depending on the crash situation, the load absorbencies/absorbency 11 and/or 12.

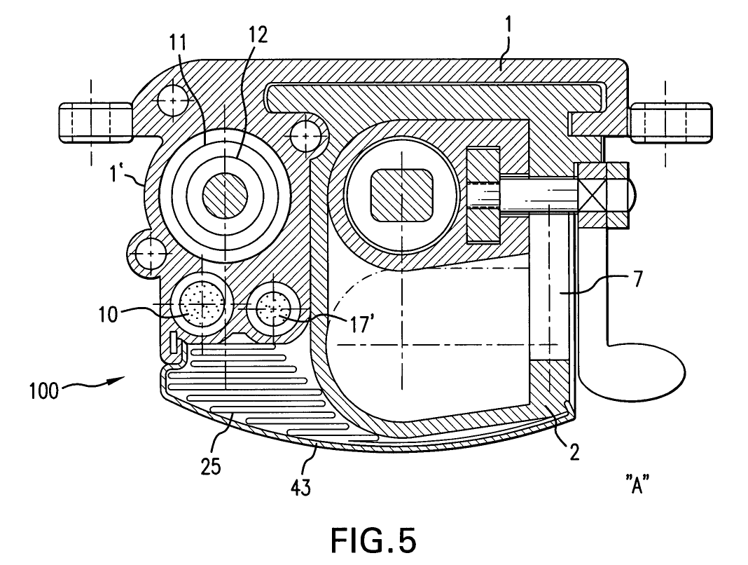

In the section A of FIG. 3 shown in FIG. 5 in the extended housing 1′, the mounting of the load absorbencies 11 and 12, and adjacent to the generator 10 for the movement of the piston 15, and the mounting of a generator 17′ for an air bag 25 are shown. A cover 43 that hooks or dovetails into appropriate slots in extended housing 1′ and outer housing 2 encloses the air bag. Further details correspond to those of the previous FIGS. 1 to 4. This section A shows furthermore the interleaving steering column correspondingly to FIGS. 1 and 2 with a guiding plate similar to the guiding plate 1 in a modified form for supporting the elements mentioned above. All elements are optimally “inter-left” and accommodated in the direction of the extruded or extrusion profiles or shapes.

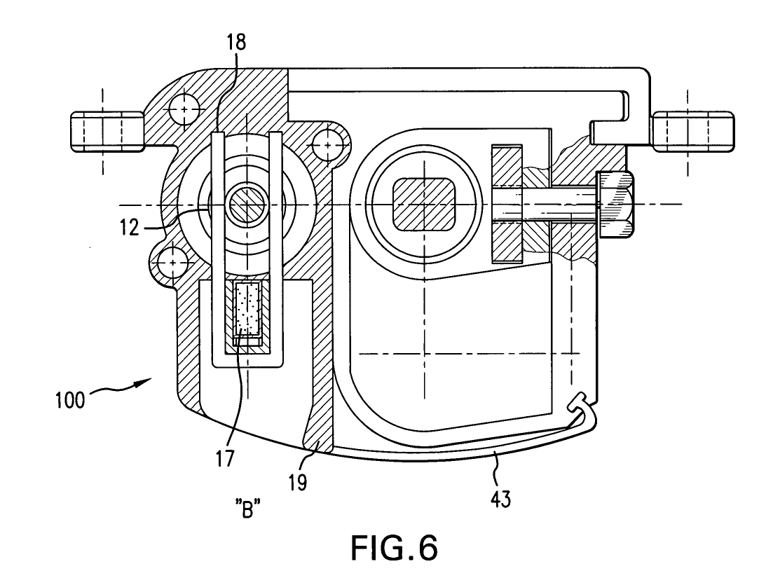

In the section B of FIG. 3, illustrated in FIG. 6, an unlocking casing 19 screwed on the extended housing 1′ is shown in section. An unlocking (pin or U-shaped element) 18 (in this case as a clamp) is seen. Bolts, plates or the like could also be used. A pyrotechnic cartridge 17 pulls the unlocking 18 of the inner load absorbency 12 away when an accident occurs according to a pregiven programming after a load absorbency has completed its function.

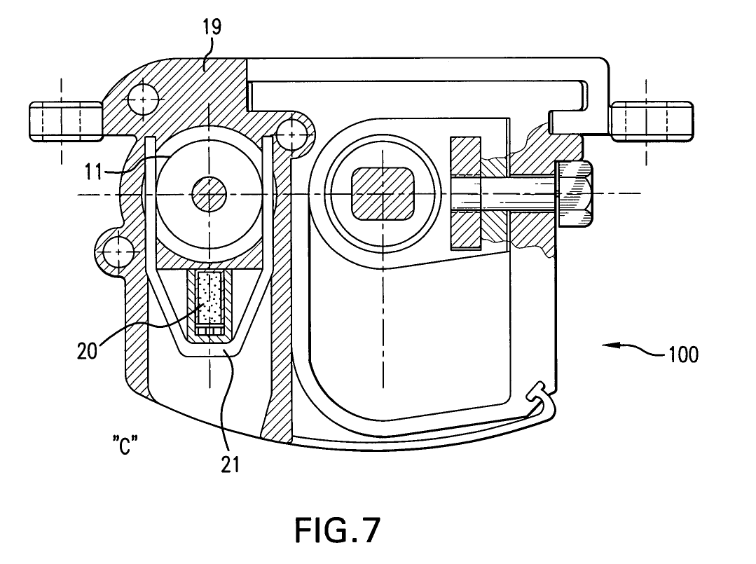

In the section C of FIG. 3, shown in FIG. 7, an unlocking 21(like 18) is able to release the outer load absorber 11 when appropriate. A second pyrotechnic cartridge 20 is provided for this function.

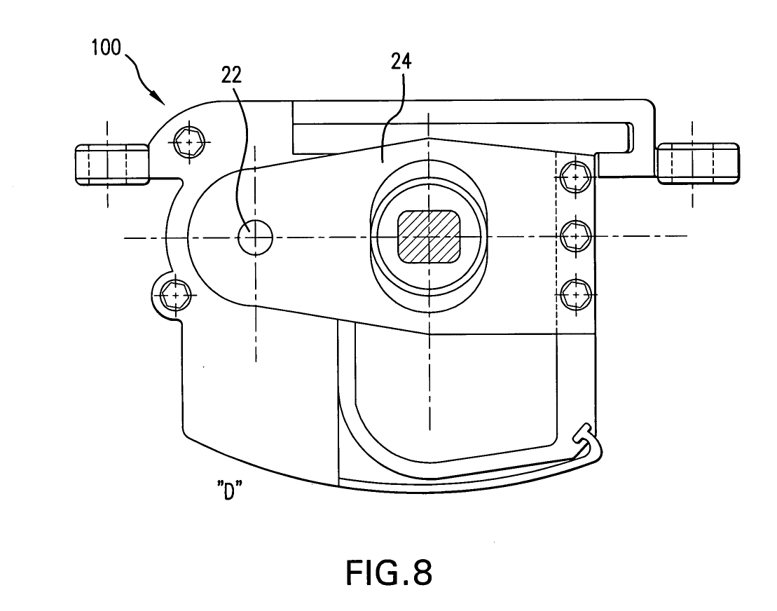

In the section D of FIG. 3, illustrated in FIG. 8, a connecting tab, plate or bar 24 is shown which connects piston rod 22 to the outer housing 2, to tie the outer housing 2 to the function of the load absorbencies. Tab 24 has an opening to enable the steering shaft to pass through.

Function in an Accident or a Crash

The crash-relevant requirements to a steering column of the described embodiment were basically described in the PCT/DE 00/02286 relating to the same applicant. Herewith, the disclosure of this PCT application with regard to the function of a retractable steering column is completely included (here incorporated by reference) in this present document to avoid mere repeating description.

If a tall man is not wearing a seat belt (detection, e.g., by means of a switch in seat belt buckle), so he will need both load absorptions 11 and 12 to absorb sufficient energy and therefore, both the inner and the outer absorbencies 11 and 12 will stay locked during the initial phase of the accident until sufficient absorption has been attained, and then will be unlocked. If the driver is wearing a seat belt, the inner load absorbency 11 will be unlocked and only the outer load absorbency 12 will be active until the accident phase dictates unlocking of the outer absorbency 12. Whether the cartridges fire or not and generate gas to drive the piston will depend on the crash considerations, i.e. if not fired, the load absorbencies will be effective against pressure imposed on the steering column e.g. by the driver striking the steering wheel. If fired, the piston will be driven by the gas generation to effect downward movement of the steering column controlled by load absorbency. The comfort controls will be locked.

If a small person is sitting close to the steering column, so he/she will not need load absorbency (air bag is sufficient). Both load absorbencies 11 and 12 will be unlocked, and the outer housing 2 will be driven by the piston via the tab 24 to the front, together with the steering column mounted thereon, to generate sufficient distance away from the person to prevent injury. The small persons' presence is detected, for example, by electric seat position detection in the seat rails and seat belt retraction and/or weight detection. The knee air bag together with its generator and tissue is also an integrated component of the extruded profile.

The electronic detection system (not shown) may be integrated into the steering column components to allow for activating or deactivating load absorbers, pyrotechnic cartridges, air bag and/or one or more of the described components. A system of sensors or detection means can be pre-programmed to respond to different crash conditions or load absorbencies or act in a particular sequence in case of an accident. The steering components may also, in an alternative design, be manually activated or deactivated by the driver. For example, the load absorbers or pyrotechnic cartridges may be manually engaged or disengaged.

Advantages of the invention are the most simple manufacturing of the highly complicated housing (having a longitudinal extension and a longitudinal axis) with multiple elements which are arranged in such a way that they can perform pre-determined movements in parallel to the longitudinal direction (longitudinal axis) or perpendicular thereto.

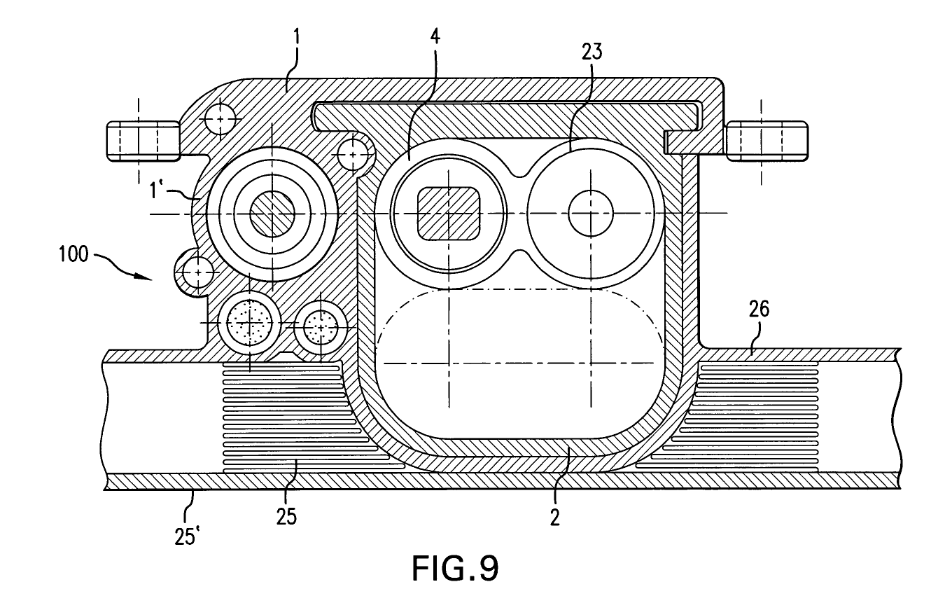

In the sectional view of FIG. 9 a further alternative is shown in which the housing 23 for the longitudinal and vertical adjustment of the steering column with electro-motors (not shown) is an integral component of the steering shaft housing 4. Furthermore, in this alternative a knee air bag 25 is integrated, in such a way, that a rear support wall 26 is an integral component of the extended housing 1′, which is an integral component of the guiding plate 1 fixed to the vehicle. Extended housing 1′ wraps around the outer housing 2 in this embodiment, but enable relative sliding and the knee air bag 25 is contained on both sides of outer housing 2 and covered by a suitable covering 25′. Both adjustment motors (not shown) are fitted in serial in the housing 23 in such a way that the rear one with its rear drive spindle (not shown) carries out the longitudinal adjustment and the front motor with a vertically adjusted drive spindle (not shown) carries out the vertical adjustment. Herein, too, everything is designed “suitably for extruded profiles”.

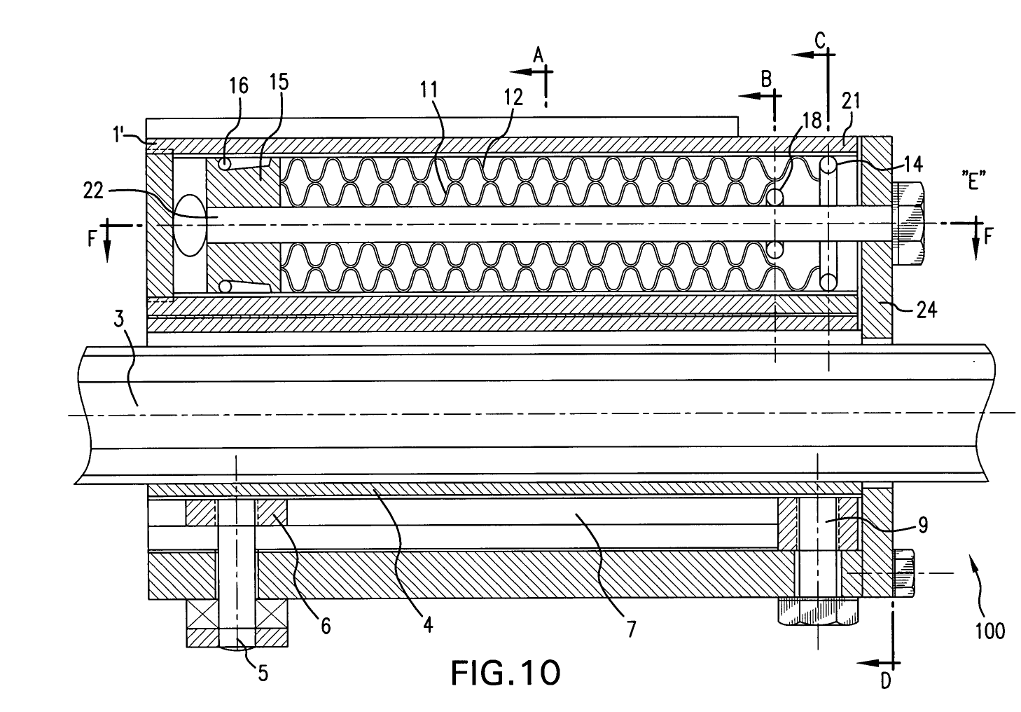

FIG. 10 shows the steering shaft 3 in the steering shaft housing 4, the lock screw 5 and the swivel bearing 9 in the horizontal section E. The extended housing 1′ with the load absorbencies 11 and 12, and the thereto belonging unlockings 18 and 21 in the unlock casings lie in parallel thereto. The steering column is driven to the front by the piston 15 on the piston rod 22 in the case of small drivers and in the second crash phase. A reverse lock 16 (reverse ball lock) prevents the steering column, once driven to the front, from pushing backwards again by the front wall of the vehicle. Load absorbencies 11 and 12 and the piston 15 are connected with outer housing 2 via the connecting tab 24 for the force transmission as described above in connection with FIG. 8 and shown in the latter.

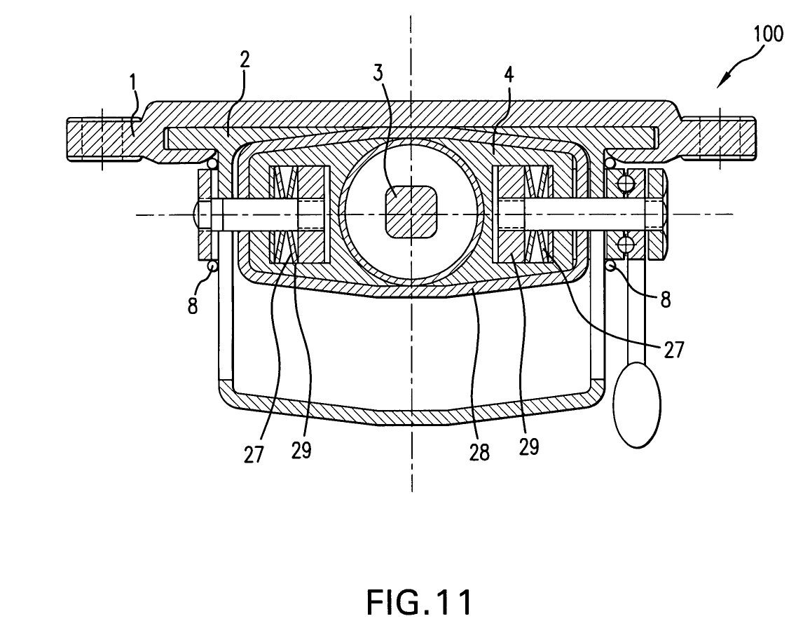

FIG. 11 shows the lock of the comfort adjustment on both sides as an alternative to the basic embodiments in FIG. 1 and 2. This is more expensive but possibly of advantage for the reduction of vibrations. According to the invention, and as shown from left to right, the tolerance is compensated by a bellville spring block 27 on each side bearing on the levers or locks 29. A load transmission casing 28, made of solid material, surrounds the steering shaft housing 4, which is made of light metal extruded profile according to the invention, for the support of the steering shaft 3 of the gliding stones or locks 29 and the bellville springs 27.

This is also a solution in which the benefits of an extruded profile are especially advantageous. The benefits of extruded or extrusion profiles or shapes have their roots in the fact that with low costs for tools, extrusion matrices are made in which complicated structural types (holes, grooves, walls, projections) can be extruded if they basically run in parallel to one direction. Therefore, the shown steering columns are illustrated in different embodiment types and the complex accommodation of load absorbers, pistons, pyrotechnic drive sets, component guides, screw holes and so on integrated in one single or in two components movable towards each other in a crash is shown.

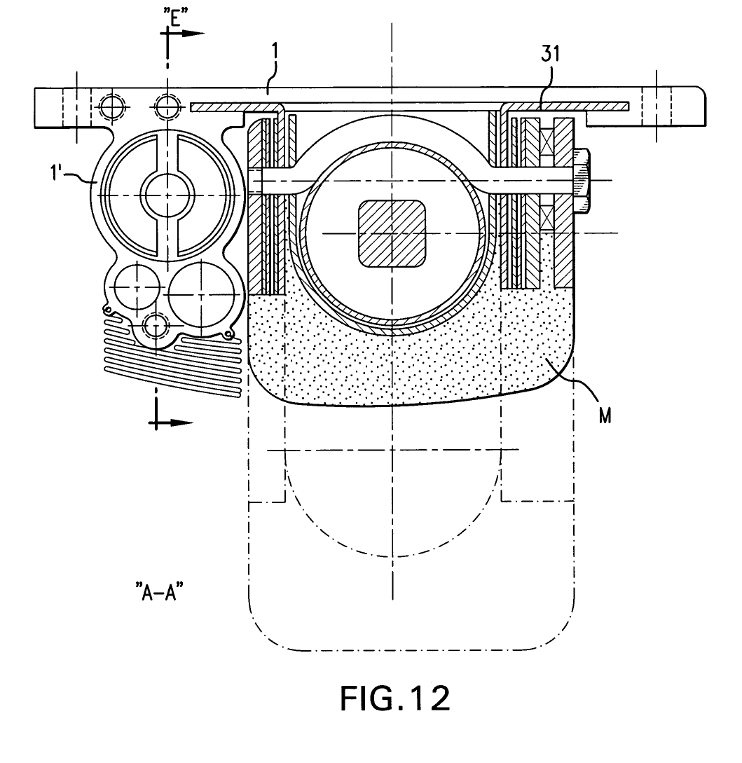

As another embodiment alternative, FIG. 12 shows the combination of a guiding plate 1 with an extended housing 1′ in which load absorbers, a pyrotechnic adjustment in the case of a crash and a knee air bag similar to what is illustrated and described thereto in the above mentioned embodiment examples and furthermore in combination with a steering column adjustment with metal sheet tabs 33. A cushioning mass M protects the driver from the steering column and supporting structure.

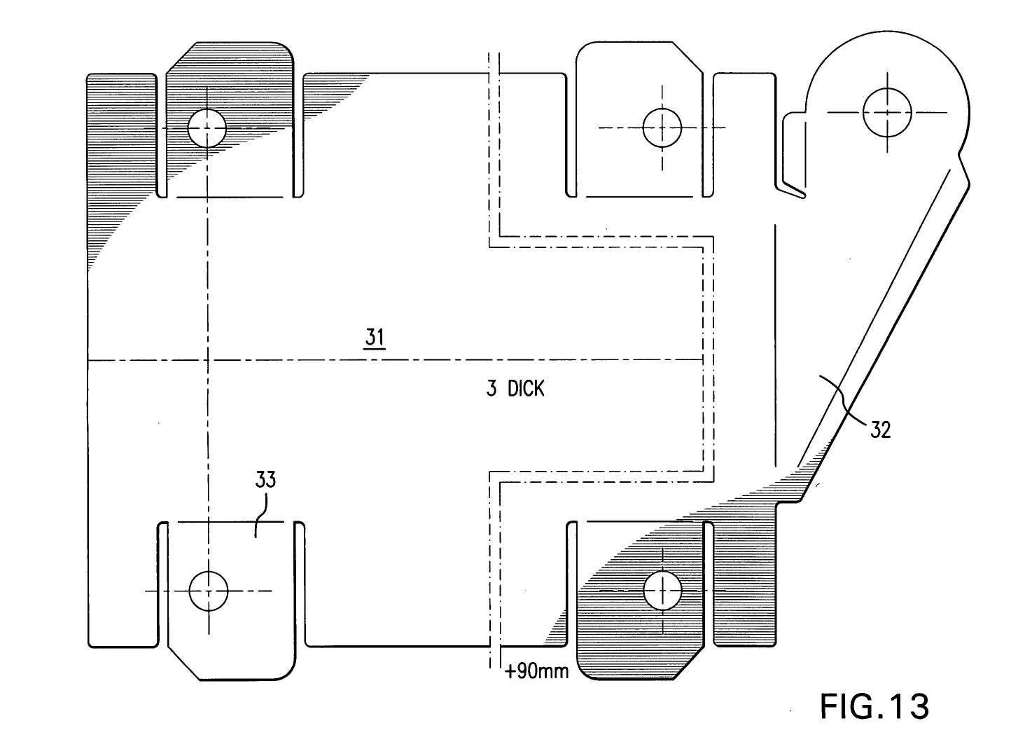

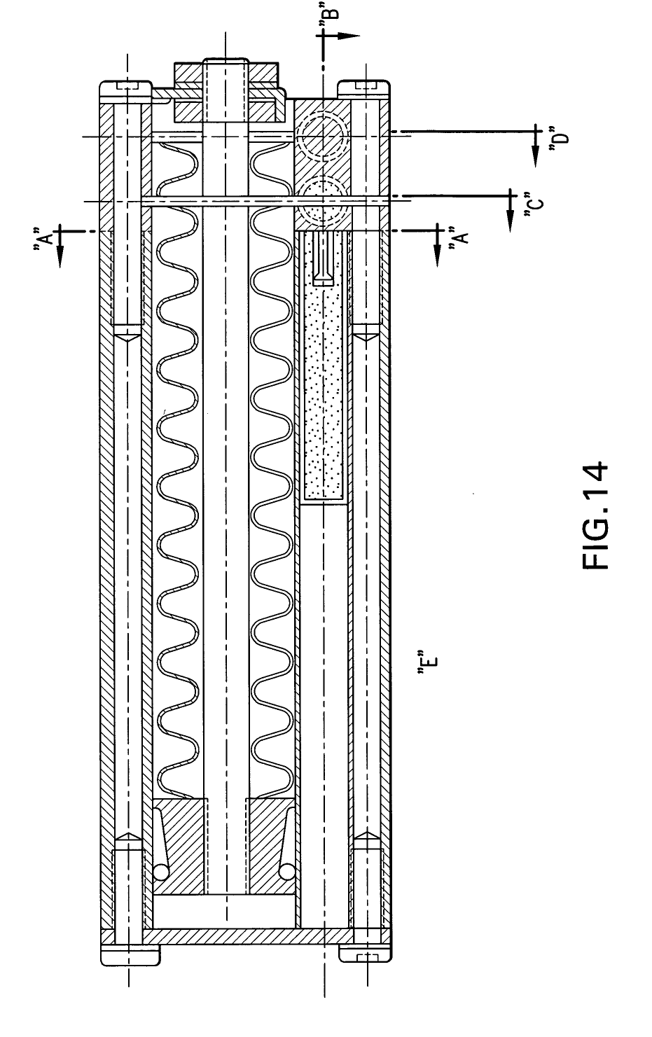

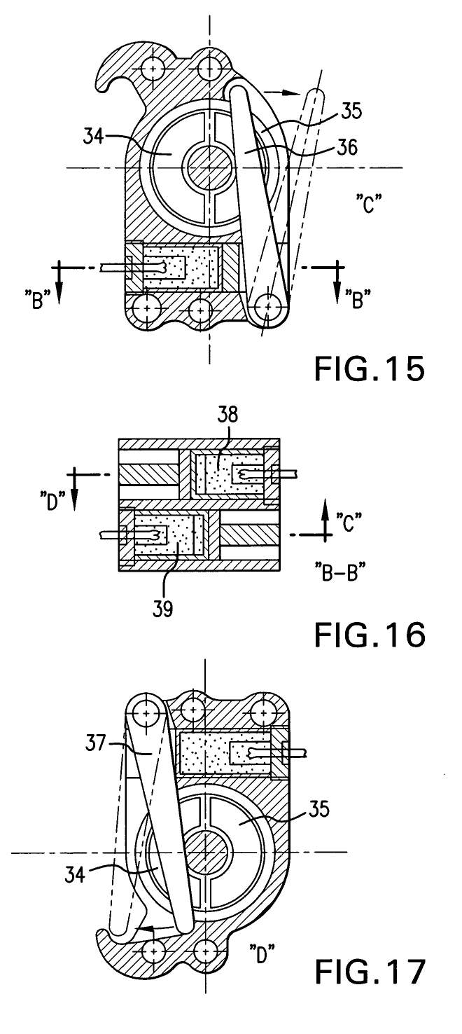

For the support of this novel steering column, a sliding or slip plate 31 according to FIG. 13 with an integrated driver 32 for coaction with load absorber 34 and 35 and the piston rod 22 according to the invention is explained. FIG. 14 shows a similar section of this embodiment correspondingly to FIG. 4 and, therefore, is not separately described except of the following differences: In the middle, FIG. 15 shows corrugated tubes as the load absorbers 34 and 35. In FIG. 15 section C a lever 36 is shown locking or, in certain described crash conditions, “unlocking” the load absorber 35. FIG. 17 shows in parallel the locking or unlocking of the load absorber 34 by means of a lever 37 depending on the crash condition. FIG. 16 shows the pyrotechnic unlocking cartridges 38 and 39 in section B. FIG. 14 shows the position of the sections A, B, and C in the steering housing or casing 40. Furthermore, FIG. 14 shows the casings 41 and 42 for the unlocking of the load absorbers 34 and 35 correspondingly to FIGS. 15,16 and 17 from the front and in the unscrewed condition.

Advantages of the single variants, as to be seen in the figures of the drawing, will be indicated in the following.

From the views of FIG. 1 and 2, it is to be seen that the guiding plate and the steering housing is made with an integrated vertically and longitudinally adjusting mechanism by using extruded or extrusion profiles or shapes in an advantageous way. In particular, it is possible therewith to accommodate the adjusting mechanism inside the steering housing in such a way that thereby no injuries can be caused in an accident.

Based on FIGS. 3 to 5, it is clear that the guiding plate, the steering housing which can be shifted for a crash case, and the vertically and horizontally adjustable steering column are made of extruded or extrusion profile or shape, respectively, which results in the already mentioned cost effectiveness. The package-optimised interleave also evident by the invention in the form of using extruded or extrusion profiles or shapes, leads to additional advantages, for example, in the case of space requirements. Furthermore, it is of advantage that the guiding plate is designed in the direction in which the profile runs and can serve as support for the longitudinally and vertically adjustable steering column, the especially inter-left embodied load absorber, preferably use driving pistons and pyrotechnic driving cartridges for a steering column movement in the case of a crash, and a knee air bag. Especially the possible integration of the knee air bag including the, e.g., tissue covered by a plate, is a further advantage.

The views of FIG. 6 and 7 illustrate the possibility of an integration of unlocking units at the end wall sides suitable to the profiles for the alternating unlocking of the load absorbers.

The connection of the glidingly mounted steering housing relative to the extended housing in connection with a driver arm for the movement of the steering column against one or two load absorbers depending on the driver's seat belt fastened condition (wearing or not wearing a seat belt) or the “shooting” of the steering column to the front in the driving direction of the vehicle, i.e., away from the driver, by means of a pyrotechnic charge using a piston with reverse lock with small drivers and in the second crash phase, is demonstrated in the illustration in FIG. 8.

The view of FIG. 9 results in the integration of a knee air bag and the supporting plate required therefore as well as an alternative knee impact plate in the extruded or extrusion profile or shapes.

FIG. 11 illustrates the embodiment of the steering column with tolerance-compensating locking on both sides for a longitudinal adjustment integrated in an extruded or extrusion profile or shape housing. This housing is again integrated in a housing made of extruded or extrusion profile or shape for the vertical adjustment which at the same time is mounted in a guiding plate also made of extruded or extrusion profile or shape, shiftable against a load absorber in a crash. The load absorber being mounted in an extended housing also an extruded profile.

All features described above correspondingly to the contents of FIGS. 3 to 10 are combined in the design according to the illustration of FIG. 12 additionally with a steering column with a “tab adjustment mechanism”. Thereto, FIG. 13 shows a sliding plate made of metal sheet with integrated bearing supports for the adjustment tabs for the vertical or height adjustment of the steering column. This sliding plate can have an integrated driver between the crash-relevant shifting part of the steering column and the pyrotechnic adjustment unit and the load absorbers.

The pyrotechnically driven switch units mounted on the power unit for locking and unlocking the load absorbers by means of swivel levers are visible in FIGS. 15 to 17.

The invention is illustrated based on the embodiment examples in the specification and in the drawings only by example and not restricted thereto but comprises all variations, modifications, substitutions and combinations which an ordinary person skilled in the art can derive from the present document, in particular in the scope of the claims and the general description in the introduction of this specification as well as the description of the embodiment examples and the illustration thereof in the drawing, and can combine with his expert knowledge as well as the prior art. In particular, all individual features and embodiment possibilities of the invention and the embodiment examples thereof can be combined.

1. A steering column having a longitudinal axis for a vehicle comprising: a guide mounted on the vehicle structure extending parallel to the longitudinal axis of the steering column; a guide member mounted slidingly movable relative to the guide; a steering shaft housing mounted to move with the guide member; said guide being an extruded profile having a longitudinally extending bore; a load absorbing member mounted in the longitudinally extending bore of the extruded profile of said guide that is operable responsive to a vehicle condition correlated with the size of the driver for accident-caused displacement of the steering column away from a driver.

2. A steering column according to claim 1 wherein the load absorbing member includes two load absorbencies.

3. A steering column according to claim 1 wherein the guide member is an extruded profile, and the guide member includes a lockable adjustment member mounted in the extruded profile of said guide member for effecting longitudinal and vertical adjustment of the steering column.

4. A steering column according to claim 1 wherein the load absorbing member includes one of a pyrotechnic and an electronic driving device.

5. A steering column according to claim 1 further including a lock member mounted with respect to the load absorber member for controlling operability, and a control device for conditioning the lock member with regard to operability of the load absorber member.

6. A steering column according to claim 2 wherein a lock member is associated with each load absorbency together with a control device for conditioning each associated lock member with regard to operability of the associated load absorbency.

7. A steering column according to claim 3 wherein a control device is provided for the adjustment member mounted in the extruded profile of said outer housing for controlling the operable condition of the adjustment member with regard to effecting longitudinal and vertical adjustment of the steering column.

8. A steering column according to claim 1 further including a device for protection of a driver's legs mounted on the steering column.

9. A steering column according to claim 8 wherein the device for the protection of a driver's legs includes an air bag.

10. A steering column according to claim 8 wherein the device for the protection of a driver's legs includes a knee impact plate.

11. A steering column according to claim 10 wherein the knee impact plate is mounted to be movable towards a driver responsive to an accident occurring.

12. A steering column according to claim 11 wherein the knee impact plate is load-absorbingly mounted.

13. A steering column for a vehicle comprising: a guide mounted on the vehicle structure; an outer housing; a steering shaft housing mounted within the outer housing; a guide plate fixed to the outer housing that coacts with said guide mounted on the vehicle structure; a housing in the form of an extruded profile attached to the guide; load absorbing member mounted in the extruded profile of said housing that is operable responsive to a vehicle condition correlated with the size of the driver for accident-caused displacement of the steering column away from a driver.

14. A steering column comprising a guide, an outer housing, a steering shaft housing and a guiding plate at least one of which is constructed in an extruded profile or in extruded profiles, said steering column having an knee airbag, means for longitudinal and vertical adjustment of the steering column accommodated in the extruded profiles of the guiding plate and the outer housing, and means for an accident-caused displacement of the steering column away from a driver accommodated in an extruded profile of the guide.

15. The steering column according to claim 14, wherein the means for the accident-caused displacement of the steering column away from the driver include load absorbing means.

16. The steering column according to claim 15, wherein the load absorbing means include two load absorbencies which can be activated or deactivated in dependence on a seat belt fastened condition and/or the size of the driver.

17. The steering column according to claim 14, wherein the means for the accident-caused movement of the steering column away from the driver include pyrotechnic or electronic driving means.

18. The steering column according to claim 14, wherein the means for the accident-caused displacement of the steering column away from the driver include pyrotechnic or electronic unlocking means for the longitudinal adjustment of the steering column and unlocking or locking means for the load absorbing means.

19. The steering column according to claim 14, further including a means for protection of a driver's knees or legs are integrated in an extruded profile.

20. The steering column according to claim 19, wherein the means for the protection of the driver's knees or legs include a knee/leg air bag and a knee impact plate especially moveable towards the driver in an accident and load-absorbingly mounted.
